(19) United States
(12) Patent Application Publication
(10) Pub. No.: US 2026/0242047 A1
(43) Pub. Date: Aug. 20, 2026

(54) FUEL TANK ARRANGEMENT, MARINE VESSEL AND METHOD FOR COOLING FUEL COMPRISING AMMONIA

(71) Applicant: WÄRTSILÄ FINLAND OY, Vaasa (FI)

(72) Inventors: Emanuele D'URSO, Vaasa (FI); Robert ENGSBO, Vaasa (FI); Rasmus WAHLBERG, Vaasa (FI); Patrik SAXÉN, Vaasa (FI); Kim GÄSTGIVARS, Vaasa (FI); Mathias SANDVIK, Vaasa (FI)

(21) Appl. No.: 19/630,932

(22) Filed: Mar. 27, 2026

Related U.S. Application Data
(63) Continuation of application No. PCT/FI2023/050592, filed on Oct. 19, 2023.

(51) Int. Cl. B63H 21/38; B63B 17/00; F02M 31/02; F02M 31/20

(52) U.S. Cl. CPC B63H 21/38; B63B 17/0027; F02M 31/02; F02M 31/20

(57) ABSTRACT

The fuel tank arrangement for a marine vessel includes a fuel tank including a shell defining a fuel space inside the shell for storing fuel, and a tank connection space connected to the fuel tank. The tank connection space includes a gas tight compartment containing tank penetrations and tank valves for fuel, an entrance to the tank connection space provided through a first space, which first space includes a gas tight compartment isolated from the tank connection space, and a first fuel outlet provided in a shell of the fuel tank within the tank connection space and connected to a first fuel line. The tank connection space further includes a first fuel inlet connected to a second fuel line and a first heat exchanger provided downstream from the first fuel line and upstream from the second fuel line.

### CROSS-REFERENCE TO RELATED APPLICATIONS

This application is a continuation of PCT International Application No. PCT/FI2023/050592 filed Oct. 19, 2023 the disclosure of this application is expressly incorporated herein by reference in its entirety.

### FIELD OF THE DISCLOSURE

The present disclosure relates to marine vessels, and more particularly to a fuel tank arrangement and a method for cooling fuel comprising ammonia.

### BACKGROUND OF THE DISCLOSURE

Fuels used in marine vessels, such as ammonia, may be harmful and/or explosive as such or cause harmful and/or explosive mixtures or compounds to be formed for instance with air. This has to be considered when structures for holding, transferring, and processing such fuels are designed. For instance, tank penetrations, pipelines, instrumentations, manholes, and similar structures in connection with fuel tanks are considered to be potential risk areas for leakages.

### BRIEF DESCRIPTION OF THE DISCLOSURE

An object of the present disclosure is to provide a new fuel tank arrangement, marine vessel, and a method for cooling fuel comprising ammonia.

The object of the disclosure is achieved by a method and an arrangement which are characterized by what is stated in the independent claims. Some embodiments of the disclosure are disclosed in the dependent claims.

The disclosure is based on an arrangement, where a subcooling circuit of fuel is provided inside a gas tight tank connection space of the fuel tank.

An advantage of the method and arrangement of the disclosure is that liquid fuel from a tank can be cooled and returned to the tank within a gas tight space connected to the tank. Thereby, even a possible leakage would be safely kept within the tank connections space.

### BRIEF DESCRIPTION OF THE DRAWINGS

In the following the disclosure will be described in greater detail by means of preferred embodiments with reference to the accompanying drawings, in which

FIGS. 1, 2, 3, 4, 5, 6, 7, 8, 9, 10 and 11 illustrate schematically different embodiments of a fuel tank arrangement,

FIG. 12 illustrates schematically a cooling system according to an embodiment,

FIG. 13 illustrates schematically a marine vessel, and

FIG. 14 illustrates schematically a method for cooling fuel comprising ammonia.

The figures are shown for illustrative purposes and are not shown to scale. Similar features in figures are indicated by same reference numbers. Not all the features are provided with reference numbers in all the figures for the sake of clarity.

### DETAILED DESCRIPTION OF THE DISCLOSURE

The disclosure relates to a fuel tank arrangement for a marine vessel, a marine vessel, and a method for cooling fuel comprising ammonia.

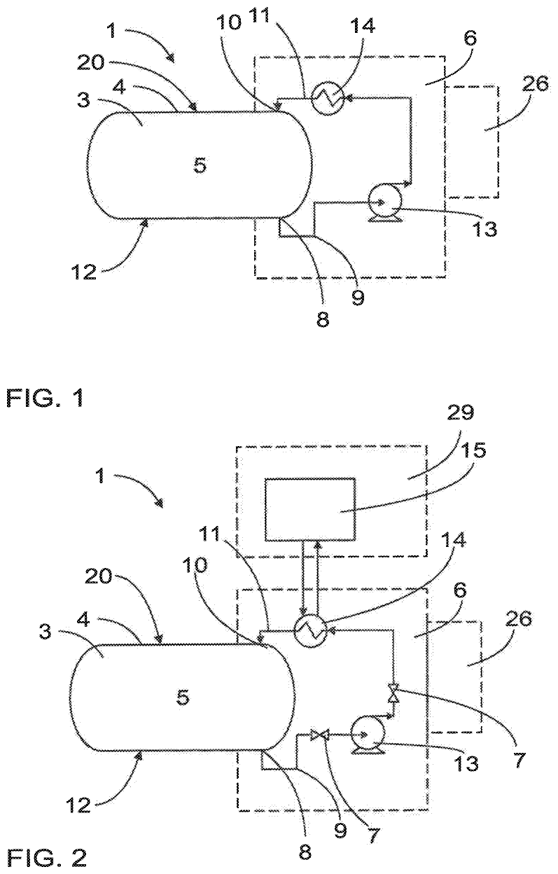

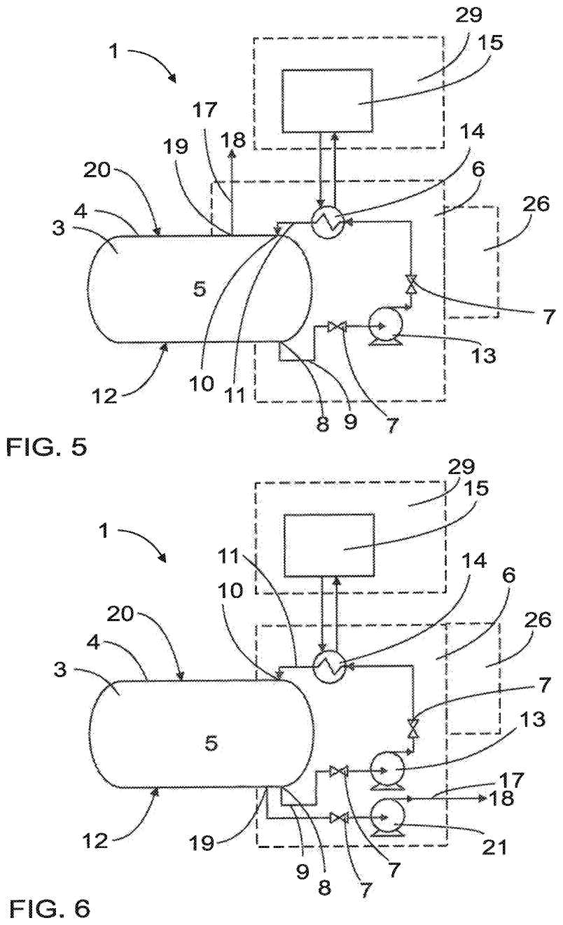

FIGS. 1 to 11 illustrate schematically different embodiments of a fuel tank arrangement 1.

According to an aspect, a fuel tank arrangement 1, more particularly a fuel tank arrangement 1 suitable for a marine vessel 2, comprises a fuel tank 3. The fuel tank 3 comprises a shell 4. The shell 4 defines a fuel space 5 inside the shell 4 for storing fuel.

The fuel tank arrangement 1 further comprises a tank connection space 6 connected to the fuel tank 3. The tank connection space 6 comprises a gas tight compartment containing tank penetrations and tank valves 7 for fuel, an entrance to the tank connection space 6 provided through a first space 26, a first fuel outlet 8, and a first fuel inlet 10. In other words, tank penetrations and tank valves for fuel, preferably all tank penetrations and tank valves for fuel, may be provided within the tank connection space 6. Tank penetrations refer to penetrations provided in the shell 4 of the fuel tank 3 for transferring fuel in and out from the fuel space 5. Tank penetrations may comprise for instance the fuel inlets and fuel outlets mentioned in this disclosure, such as the first fuel outlet 8, the first fuel inlet 9, the second fuel outlet 19, the second fuel inlet 24 and so on. Tank valves 7 may comprise tank related valves for fuel, such as those shown in the figures.

The first space 26 comprises a gas tight compartment isolated from the tank connection space 6. The first fuel outlet 8 is provided in a shell 4 of the fuel tank 3 within the tank connection space 6 and connected to a first fuel line 9. The first fuel outlet 8 is provided in the area of the lowest 30 percent of the fuel space 5 of the fuel tank 3 for connecting the fuel tank 3 to the first fuel line 9. According to an embodiment, the first fuel outlet 8 being provided in the area of the lowest 30 percent of the fuel space 5 enables receiving fuel in liquid phase via the first fuel outlet 8 to the first fuel line 9. According to an embodiment, the first fuel outlet 8 may be provided in the area of the lowest 20 percent of the fuel space 5, preferably in the area of the lowest 10 percent of the fuel space 5, and most preferably the first fuel outlet 8 may be provided in a bottom 12 of the fuel space 5.

The first fuel inlet 10 is provided in the shell 4 within the tank connection space 6 and connected to a second fuel line 11.

The tank connection space 6 further comprises a first heat exchanger 14 provided downstream from the first fuel line 9 and upstream from the second fuel line 11.

The first fuel line 9, the second fuel line 11, and the first heat exchanger 14 form at least a part of a subcooling circuit 28 for the fuel, wherein the first heat exchanger 14 is configured to cool fuel provided in the subcooling circuit. According to an embodiment, the first heat exchanger 14 is configured to cool fuel in the subcooling circuit 28. In the fuel tank arrangement 1, the subcooling circuit 28 is provided inside the tank connection space 6. In other words, the fuel is, thus, kept inside the tank connection space 6 along the subcooling circuit 28. An advantage of this is that the subcooling circuit 28 is provided inside a gas tight space isolated from the surrounding space, whereby for instance a leakage of fuel can be controlled and limited to the tank connection space 6. According to an embodiment, fuel in the subcooling circuit may be kept in the liquid phase along the entire subcooling circuit 28.

According to an embodiment, an access between the first space 26 and the tank connection space 6, such as a hatch or a door, may be bolted. According to an embodiment, the first space 26 may comprise a basic airlock space. According to an embodiment, access to the first space 26 may be configured to be closed by a lock suitable for basic airlock spaces.

According to an embodiment, the tank connection space 6 may be provided with a first ventilation arrangement (not shown) and the first space 26 may be provided with a second ventilation arrangement (not shown), whereby the first space 26 and the tank connections space 6 may be ventilated separately from one another. The tank connection space 6 may be for instance provided with a first ventilation inlet (not shown) configured to connect the tank connection space 6 to inlet ventilation piping (not shown) and a first ventilation outlet (not shown) configured to connect the tank connection space 6 to outlet ventilation piping (not shown).

According to an embodiment, the ventilation to the tank connection space 6 and the first space 26 is configured to be arranged and/or controlled separately in such a manner, that ventilation in each space 6, 26 can be determined and controlled separately according to different needs and requirements. This may be provided by providing a separate ventilation inlet piping and/or a separate ventilation outlet piping for the tank connection space 6 and the first space 26. Thus, the ventilation inlet piping and/or ventilation outlet piping for each one of the tank connection space 6 and the first space 26 may comprise separate pipes not connected to each other.

According to an embodiment, the outlet ventilation piping may be isolated from the tank hold space. In other words, the content of the outlet ventilation piping may be isolated from the tank hold space, which tank hold space surrounds the fuel tank 3, the tank connection space 6 and the first space 26. According to an embodiment, the outlet ventilation piping may be configured to guide the outlet air from the tank connection space 6 and from the first space 26 to outside air outside the tank hold space. Depending on the embodiment, the outlet ventilation piping may comprise separate pipes, or lines, for outlet air from the tank connection space 6 and from the first space 26, which separate pipes are not connected to each other in any way, or the pipes or lines connected to the tank connection space 6 and to the first space 26 may be connected to each other at a point within the tank hold space or outside a hull of the marine vessel 2.

According to an embodiment, the inlet ventilation piping may be isolated from the tank hold space. In other words, the content of the inlet ventilation piping may be isolated from the tank hold space. According to an embodiment, the inlet ventilation piping may be configured to guide the inlet air to the tank connection space 6 and to the first space 26. Depending on the embodiment, the inlet ventilation piping may comprise separate pipes, or lines, for inlet air to the tank connection space 6 and to the first space 26, which separate pipes are not connected to each other in any way, or the pipes or lines connected to the tank connection space 6 and to the first space 26 may be connected to each other at a point within the tank hold space or outside the hull of the marine vessel 2.

According to an embodiment, the first space 26 and/or the tank connection space 6 may be configured to be ventilated, namely to be ventilated via the first ventilation inlet and the first ventilation outlet, at least 10 air changes per hour. In other words, an amount of air equal to at least 10 times the volume of the first space 26 and/or the tank connection space 6 may be provided to and out from the first space 26 and/or the tank connection space 6, respectively, in an hour. According to an embodiment, the first space 26 and/or the tank connection space 6 may be configured to be ventilated at least 30 air changes per hour. According to an embodiment, the first space 26 and/or the tank connection space 6 may be configured to be ventilated, or ventilated, at least 10 air changes, and preferably at least 30 air changes, per hour continuously during normal operation of the fuel tank 3.

According to an embodiment, the ventilation comprises a suction-based ventilation. In other words, the ventilation may be arranged by suction, in other words underpressure, rather than providing pressurized air. According to an embodiment, the first ventilation arrangement and/or the second ventilation arrangement may be provided with a gas detector (not shown) configured to detect a leak from the fuel tank 3 to the tank connection space 6. In other words, the gas detector may be provided in fluid connection with the tank connection space 6. This may be beneficial, as a leak from the fuel tank to the tank connection space 6 may be detected early and safety may be ensured before a maintenance person enters the tank connection space 6 for instance for maintaining the subcooling circuit 28.

According to an embodiment, the subcooling circuit 28 further comprises a first pump 13 for circulating the fuel in the subcooling circuit 28. In other words, the first pump 13 may be configured to transfer fuel from the first fuel outlet 8 via the first fuel line 9 to the first heat exchanger 14 and further to the first fuel inlet 10 via the second fuel line 11. In other words, the first pump 13 may be provided in fluid connection with the first fuel outlet 8, the first fuel line 9, the first heat exchanger 14, the second fuel line 11, and the first fuel inlet 10. In this disclosure, a pump, such as the first pump 13, refers to a device capable of transferring fuel, especially fuel in liquid form, in a circuit, such as the subcooling circuit 28. According to an embodiment, the first pump 13 may comprise a device not intended for transferring fluids, for instance fuel, in gaseous form.

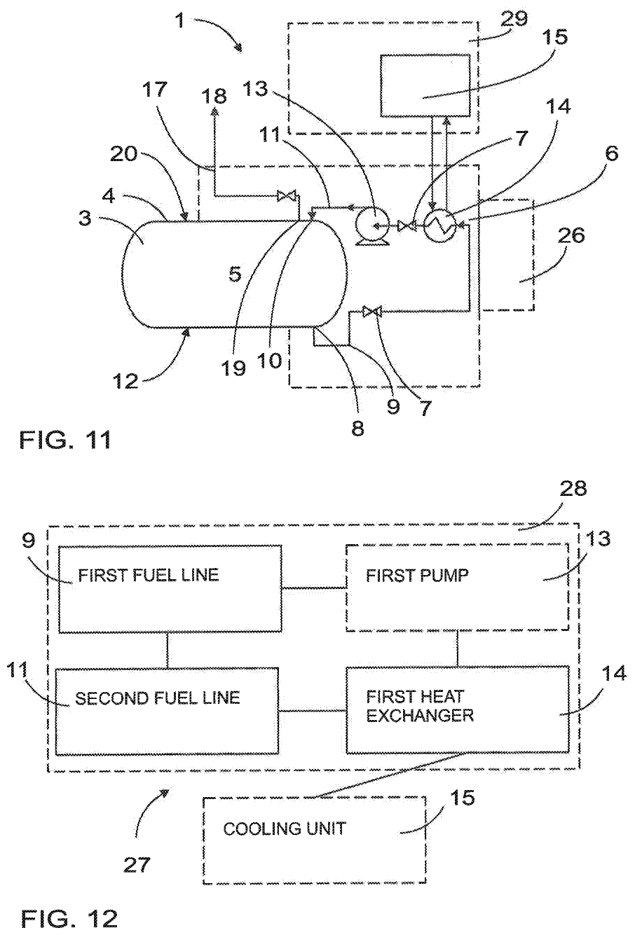

According to an embodiment, the first heat exchanger 14 is provided downstream from the first pump 13. In other words, the first pump 13 may be provided upstream from the first heat exchanger 14, such as illustrated in the embodiments of FIGS. 1 to 10. According to an embodiment, the first heat exchanger 14 mat be provided upstream from the first pump 13, such as illustrated in FIG. 11.

According to an embodiment, the subcooling circuit 28 may form a part of a cooling system 27 of the fuel. According to an embodiment, the cooling system 27 may further comprise a cooling unit 15. According to an embodiment, the cooling unit 15 may comprise a heat pump. According to an embodiment, the cooling unit 15 may comprise an electrically operated heat pump. According to an embodiment, the cooling unit 15 may be provided in a second space 29 outside the tank connection space 6. An advantage of such embodiments may be for instance that the cooling unit 15 does not heat the tank connections space 6. The second space 29 may preferably comprise a so-called safe area, whereby the second space 29 is separated from areas intentionally or potentially comprising fuel, for instance gaseous fuel leakages. The safe area may comprise an area, which is safe, for instance safe according to applicable standards, for electrical equipment. Such embodiments may also be beneficial, because the tank connection space 6 may be made considerably smaller.

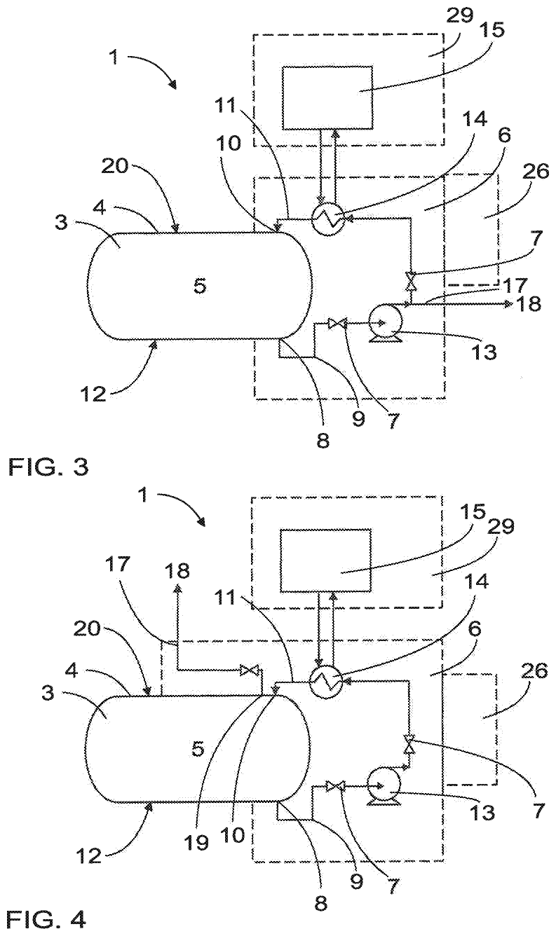

According to an embodiment, the tank connection space 6 further comprises a third fuel line 17, which third fuel line 17 is configured to supply fuel to one or more consumers 18. In other words, the third fuel line 17 may connect the fuel tank 3, directly or via other fuel lines, to one or more consumers 18. According to an embodiment, the subcooling circuit 28 and fuel supply to the one or more consumers 18 may share the first fuel outlet 8, the first fuel line 9 and the first pump 13, whereby the same first pump 13 is configured to circulate fuel in the subcooling circuit and transfer fuel to the consumer(s) 18. In other words, the first pump 13 may be connected to both the subcooling circuit 28 and the third fuel line 17, such an in the embodiments illustrated in FIGS. 3, 7, 8, and 9.

According to another embodiment, the tank connection space 6 may further comprise a second fuel outlet 19 provided in the shell 4 within the tank connection space 6, wherein the second fuel outlet 19 may be connected to the third fuel line 17. In other words, the third fuel line 17 configured to supply fuel to one or more consumers 18 may be separated from the subcooling circuit 28, such as in the embodiments illustrated in FIGS. 4, 6, 10, and 11. According to an embodiment, such as the embodiment of FIG. 6, a second pump 21 may be provided in fluid connection with the second fuel outlet 19 and the third fuel line 17. The second pump 21 may be configured to transfer fuel from the second fuel outlet 19 via the third fuel line 17 to the one or more consumers 18.

According to an embodiment, the second fuel outlet 19 may be provided in the area of the highest 20 percent of the fuel space 5. This may be beneficial in some embodiments since it may enable connecting the fuel in gaseous phase to the third fuel line 17. According to an embodiment, the second fuel outlet 19 may be provided in a top 20 of the fuel space 5.

According to another embodiment, the second fuel outlet 19 may be provided in the area of the lowest 20 percent of the fuel space 5 for connecting the fuel to the third fuel line 17. According to an embodiment, the second fuel outlet 19 may be provided in the bottom 12 of the fuel space 5.

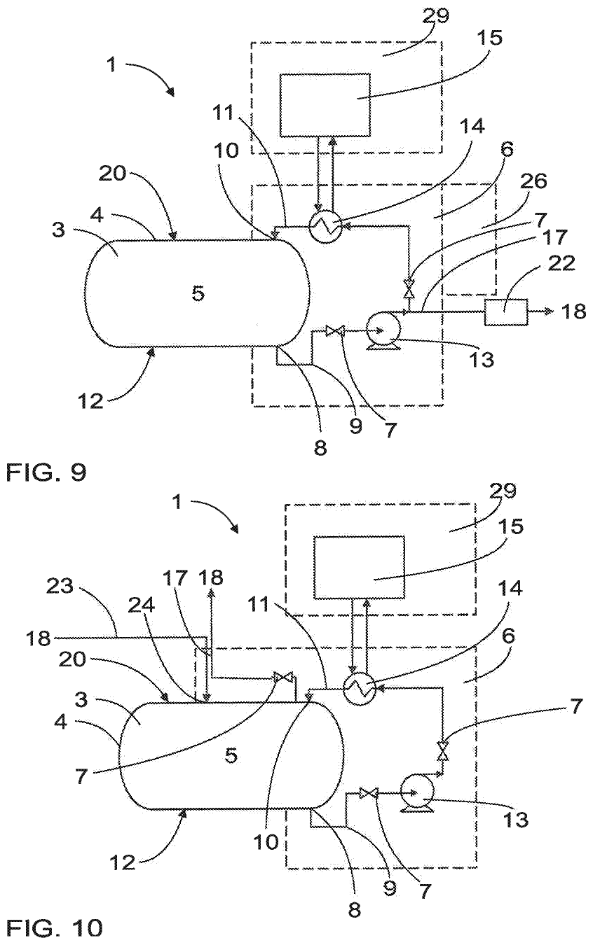

According to an embodiment, equipment 22 for warming fuel to be supplied to the one or more consumers 18 may be provided in the third fuel line 17 upstream from the consumer(s) 18, such as in the embodiment illustrated in FIG. 9. This may be beneficial for instance if it is beneficial to provide the fuel in gaseous phase to the consumer, such as the engine. According to an embodiment, the equipment 22 for warming fuel to be supplied to the one or more consumers 18 may be provided outside the tank connection space 6.

According to an embodiment, the first fuel line 9 between the first fuel outlet 8 and the first pump 13 does not comprise any equipment for heating the fuel received from the fuel tank 3. Thereby, in the subcooling circuit 28, the temperature of the fuel may only be affected by cooling the fuel. According to an embodiment, the fuel may, thus, be kept in liquid phase along the subcooling circuit including the first heat exchanger 14.

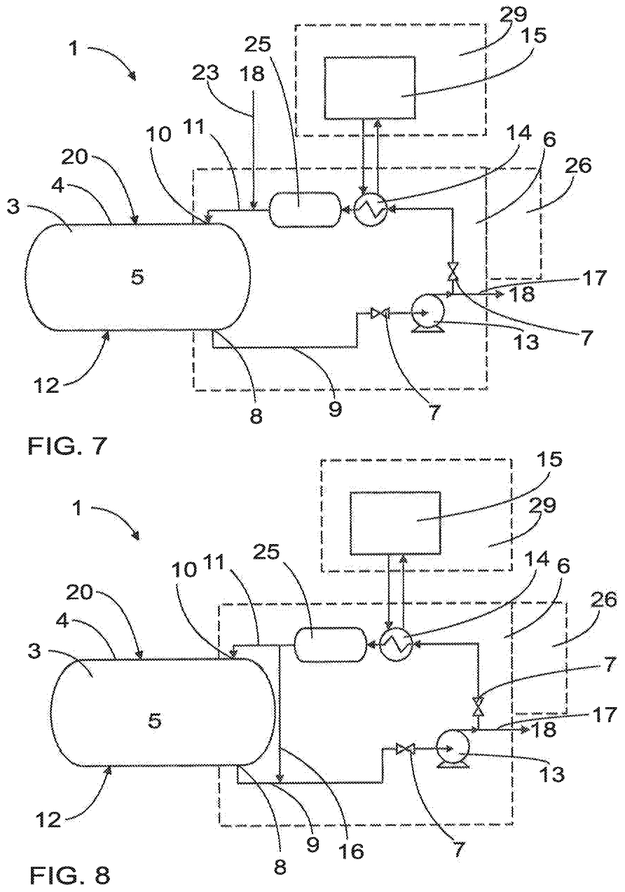

According to an embodiment, the tank connection space 6 may further comprise a return line 23 for receiving excess fuel from one or more consumers 18, such as in embodiments illustrated in FIGS. 7 and 10. Depending on the embodiment, the return line 23 may be connected to the fuel tank 3 via the second fuel line 11, such as in the embodiment illustrated in FIG. 7, or a second fuel inlet 24 provided in the shell 4 within the tank connection space 6, such as in the embodiment illustrated in FIG. 10.

According to an embodiment, at least one consumer 18 comprises an engine, such as an internal combustion engine.

According to an embodiment, the subcooling circuit 28 may further comprise a recirculation line 16 connecting the second fuel line 11 downstream from the first heat exchanger 14 to the first fuel line 9 upstream from the first pump 13. According to such an embodiment, the fuel, or a part of the fuel, may be recirculated in the subcooling circuit 28 to circulate it through the first heat exchanger 14 more than one time, for instance to further cool the fuel.

According to an embodiment, the tank connection space 6 may further comprise an auxiliary tank 25 provided downstream from the first heat exchanger 14 and upstream from the first fuel inlet 10, such as in the embodiment illustrated in FIGS. 7 and 8.

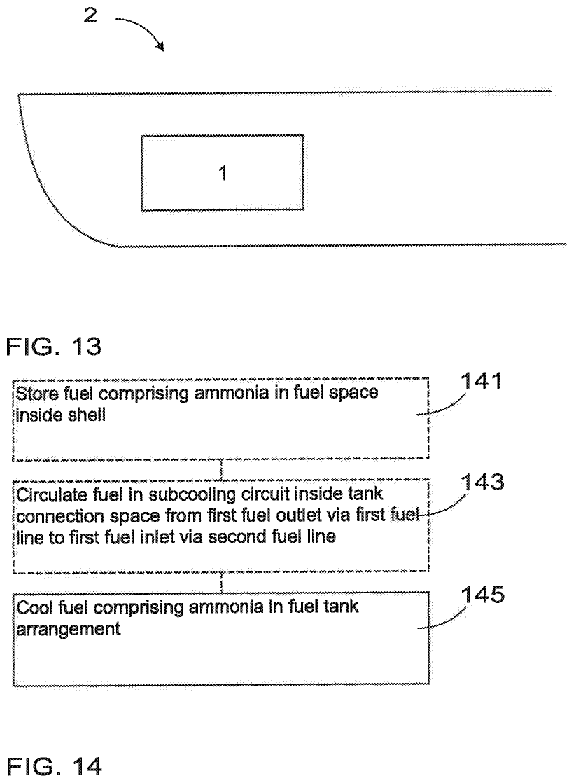

FIG. 13 illustrates schematically a marine vessel 2.

According to an aspect, a marine vessel 2 comprises a fuel tank arrangement 1 according to an embodiment or a combination of embodiments disclosed in this description and/or accompanying claims and/or drawings.

According to an embodiment, the fuel tank 3 may be provided under a deck of the marine vessel 2. According to an embodiment, a tank hold space (not shown) comprises a space that surrounds the fuel tank 3, the tank connection space 6, and the first space 26.

FIG. 14 illustrates schematically a method for cooling fuel comprising ammonia.

According to an aspect, a method for cooling fuel comprising ammonia comprises cooling 145 the fuel comprising ammonia in a fuel tank arrangement 1 according to an embodiment or a combination of embodiments disclosed in this description and/or accompanying claims and/or drawings.

According to an embodiment, the method comprises storing 141 fuel comprising ammonia in the fuel space 5 inside the shell 4 and circulating 143 the fuel in the subcooling circuit 28 inside the tank connection space 6 from the first fuel outlet 8 via the first fuel line 9 to the first fuel inlet 10 via the second fuel line 11.

According to an embodiment, the ammonia fuel is kept in a liquid form during the circulation in the subcooling circuit 28.

According to an embodiment, circulating the fuel in the subcooling circuit comprises circulating the fuel from the first fuel line 9 to the first heat exchanger 14 by the first pump 13, cooling the fuel in the first heat exchanger 14, and returning the fuel back to the fuel tank 3 from the first heat exchanger 14 via the second fuel line 11.

1.-25. (canceled)

26. A fuel tank arrangement for a marine vessel, comprising:
a fuel tank including a shell defining a fuel space inside the shell for storing fuel, and
a tank connection space connected to the fuel tank, wherein the tank connection space comprises:
a gas tight compartment containing tank penetrations and tank valves for fuel,
an entrance to the tank connection space provided through a first space, which first space comprises a gas tight compartment isolated from the tank connection space, and
a first fuel outlet provided in a shell of the fuel tank within the tank connection space and connected to a first fuel line, wherein
the tank connection space further comprises:
a first fuel inlet provided in the shell within the tank connection space and connected to a second fuel line, and
a first heat exchanger provided downstream from the first fuel line and upstream from the second fuel line, wherein
the first fuel outlet is provided in the area of the lowest 30 percent of a fuel space of the fuel tank for connecting the fuel tank to the first fuel line,
the first fuel line, the second fuel line, and the first heat exchanger form at least a part of a subcooling circuit for the fuel, wherein the first heat exchanger is configured to cool fuel provided in the subcooling circuit, and
that the subcooling circuit is provided inside the tank connection space.

27. The fuel tank arrangement according to claim 26, wherein the subcooling circuit further comprises a first pump for circulating the fuel in the subcooling circuit.

28. The fuel tank arrangement according to claim 27, wherein the first heat exchanger is provided downstream from the first pump.

29. The fuel tank arrangement according to claim 26, wherein the subcooling circuit forms a part of a cooling system of the fuel, wherein the cooling system further comprises a cooling unit.

30. The fuel tank arrangement according to claim 29, wherein the cooling unit is provided in a second space outside the tank connection space.

31. The fuel tank arrangement according to claim 29, wherein the cooling unit comprises a heat pump.

32. The fuel tank arrangement according to claim 26, wherein the tank connection space further comprises:
a third fuel line configured to supply fuel to one or more consumers.

33. The fuel tank arrangement according to claim 32, wherein the subcooling circuit and fuel supply to the one or more consumers share the first fuel outlet, the first fuel line and the first pump,
whereby the same pump is configured to circulate fuel in the subcooling circuit and transfer fuel to the consumer(s).

34. The fuel tank arrangement according to claim 32, wherein the tank connection space further comprises a second fuel outlet provided in the shell within the tank connection space and connected to the third fuel line.

35. The fuel tank arrangement according to claim 32, wherein equipment for warming fuel to be supplied to the one or more consumers is provided in the third fuel line upstream from the consumer(s).

36. The fuel tank arrangement according to claim 35, wherein the equipment for warming fuel to be supplied to the one or more consumers is provided outside the tank connection space.

37. The fuel tank arrangement according to claim 27, wherein the first fuel line between the first fuel outlet and the first pump does not comprise any equipment for heating the fuel received from the fuel tank, whereby, in the subcooling circuit, the temperature of the fuel is only affected by cooling the fuel.

38. The fuel tank arrangement according to claim 32, wherein the tank connection space further comprises a return line for receiving excess fuel from one or more consumers, which return line is connected to the fuel tank via the second fuel line or a second fuel inlet provided in the shell within the tank connection space.

39. The fuel tank arrangement according to claim 32, wherein at least one consumer comprises an engine.

40. The fuel tank arrangement according to claim 26, wherein the subcooling circuit further comprises a recirculation line connecting the second fuel line downstream from the first heat exchanger to the first fuel line upstream from the first pump.

41. The fuel tank arrangement according to claim 26, wherein the tank connection space further comprises an auxiliary tank provided downstream from the first heat exchanger and upstream from the first fuel inlet.

42. The fuel tank arrangement according to claim 26, wherein the first fuel outlet is provided in the area of the lowest 20 percent of the fuel space.

43. The fuel tank arrangement according to claim 42, wherein the first fuel outlet is provided in the area of the lowest 10 percent of the fuel space.

44. The fuel tank arrangement according to claim 43, wherein the first fuel outlet is provided in a bottom of the fuel space.

45. The fuel tank arrangement according to claim 26, wherein the tank connection space is provided with a first ventilation arrangement and the first space is provided with a second ventilation arrangement, whereby the first space and the tank connection space are ventilated separately from one another.

46. A marine vessel comprising a fuel tank arrangement according to claim 26.

47. A method for cooling fuel comprising ammonia, wherein the fuel comprising ammonia is cooled in a fuel tank arrangement according to claim 26.

48. The method according to claim 47, wherein the method further comprises:
storing fuel comprising ammonia in the fuel space inside the shell, and circulating the fuel in the subcooling circuit inside the tank connection space from the first fuel outlet via the first fuel line to the first fuel inlet via the second fuel line.

49. The method according to claim 47, wherein the ammonia fuel is kept in a liquid form during the circulation in the subcooling circuit.

50. The method according to claim 47, wherein circulating the fuel in the subcooling circuit comprises:
circulating the fuel from the first fuel line to the first heat exchanger by the first pump, cooling the fuel in the first heat exchanger, and
returning the fuel back to the fuel tank from the first heat exchanger via the second fuel line.
